(19) United States
(12) Patent Application Publication
(10) Pub. No.: US 2006/0049813 A1
(43) Pub. Date: Mar. 9, 2006

(54) Three-Level dc-ac converter

(76) Inventor: Machiel Antonius Martinus Hendrix, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/541,978

(22) PCT Filed: Dec. 5, 2003
(86) PCT No.: PCT/IB03/05823

§ 371 Date: Jul. 11, 2005

(30) Foreign Application Priority Data
Jan. 14, 2003 (EP) 03100045.8

(51) Int. Cl. G05F 1/40

(52) U.S. Cl. 323/282

(57) ABSTRACT

The invention relates to a DC/AC-converter for supply of TL-lamps, comprising a bridge circuit of switch elements, a control circuit for control of the switch elements, so that subsequently a ground voltage, a positive voltage, a ground voltage, a negative voltage and a ground voltage is obtained on the first output, wherein the TL-lamp is to be connected between the first an the second output. This arrangement of the switching elements avoids periods of time during which the lamp voltage is kept floating so that flickering of the lamp is avoided.

The invention relates to a DC/AC converter for the supply of TL-lamps which is adapted to supply the lamp with a three level voltage.

Such converters are generally known.

They comprise two switch elements which are adapted to subsequently connect one connection of the lamp with a positive and a negative supply voltage respectively. To avoid short circuits between the positive and the negative voltage, the switch element being on is switched off before the other switch element is switched on. Consequently during a short period of time the lamp is connected with neither the positive nor the negative supply voltage. During these short periods, the voltage supplied to the lamp is floating. This means that the voltage is determined by capacitances between conductors of said voltage and ground etc. and by the electric charges present during the switching off of the switch element concerned. As a consequence thereof the lamp will be subjected to an annoying flickering.

The aim of the invention is to avoid the floating of the voltage supplied to the lamp during any moment of the switching cycle.

This aim is reached by a DC/AC converter for supply of TL-lamps, comprising a first input to be connected to a positive DC voltage, a second input to be connected to a negative DC voltage, a third input to be connected to a ground voltage, a series connection of a first, a second, a third and a fourth switch element between the first connection and the second connection, a first diode of which the anode is connected to the third input and of which the cathode is connected to the junction of the first and the second switch element, a second diode of which the anode is connected to the junction between the third and the fourth switch element and the cathode of the diode is connected to the third input, an inductor, connected between the junction between the second and third switch elements and a first output, a second output connected to third input and a control circuit for controlling the first to fourth switch elements, such that subsequently a ground voltage, a positive voltage, a ground voltage, a negative voltage and a ground voltage is obtained on the first output, wherein the TL-lamp is to be connected between the first and the second output.

This arrangement of the switching elements avoids periods of time during which the lamp voltage is kept floating so that flickering of the lamp is avoided.

It is noted that from U.S. Pat. No. 5,155,675 a three phase DC/AC inverter is known which comprises the same configuration of switch elements as the present invention. This document concerns the control of three phase motors for electric railcars, that is a different field of engineering. Further the aim of this prior art design is to make the transition from three-pulse mode to the single pulse mode used at higher speeds less noticeable. This is another problem which is not present in the supply of gas discharge lamps.

Besides the construction according to the present invention has the advantage that the breakdown voltage for which each of the transistors must be dimensioned, can be the half of the same value for each of the two transistors in the prior art construction, allowing semiconductors to be used, which are easier and hence cheaper to produce.

According to a preferred embodiment the third input is connected to the first input by a first capacitor, and to the second input by a second capacitor, wherein both capacitors have substantially the same capacitance.

The configuration according to the main claim is applicable to situations wherein three supply voltages are available, that is a positive supply voltage, a ground voltage and a negative supply voltage. In most situations only a positive voltage and a negative voltage are available. This preferred embodiment allows provides a simple cost effective solution for the generation of an intermediate voltage which can be used as ground voltage.

The configuration according to the present invention is especially applicable as a supply unit for TL lamps. As these are present huge numbers, it is feasible to develop these units for mass production.

A preferred embodiment teaches that each of the switch elements is formed by a semiconductor switch element and that each of the switch elements comprises a bypass diode connected anti-parallel to the semiconductor element.

This allows the switch elements, the free wheel diodes, the other diodes and the control unit to be implemented in a single integrated circuit, contributing to lowering of costs.

In this respect it is noted that to be able to absorb the voltage surges caused by the switching of the switch elements in the prior art circuit comprising only two switch elements, the free wheel diodes have to be of a special construction, inhibiting implementation in integrated form by technologies used for the implementation of the switch elements. The present invention produces less high voltage surges which can be absorbed by free wheel diodes of more conventional construction, allowing the free wheel diodes to be integrated by the same technologies as the switch elements.

When not only the switch elements but also the control circuits is incorporated into a single semiconductor chip, the advantages of integration extend even further.

Subsequently the present invention will be elucidated with the help of the accompanying drawings in which:

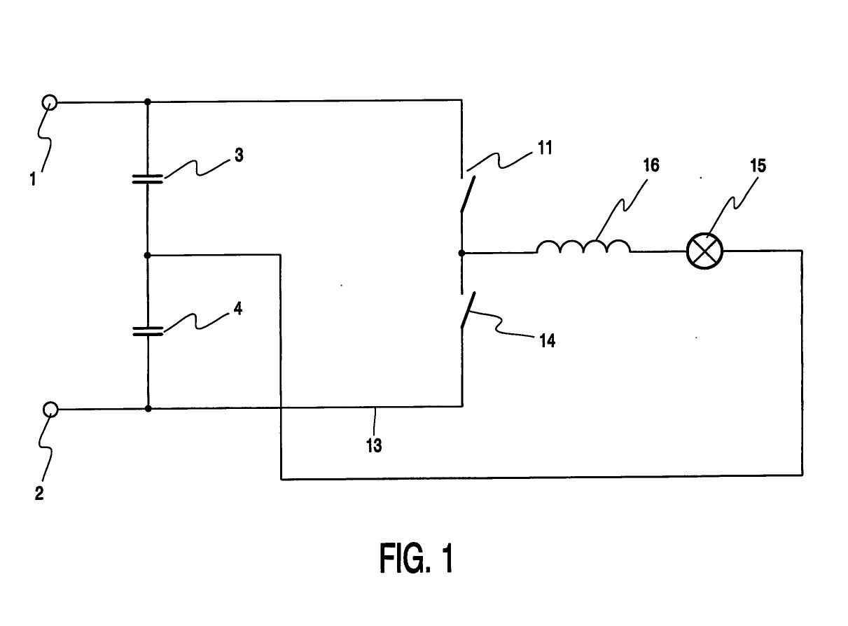

FIG. 1 shows a circuit diagram of a prior art circuit for supplying a TL-lamp;

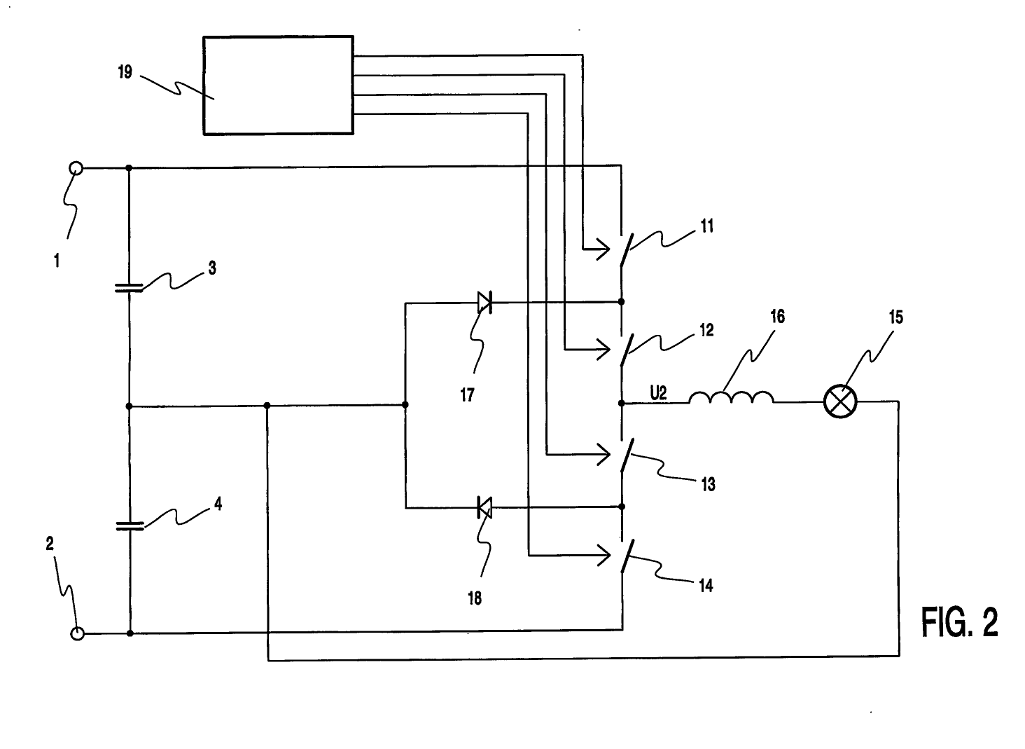

FIG. 2 shows a circuit diagram of a circuit according to the invention; and

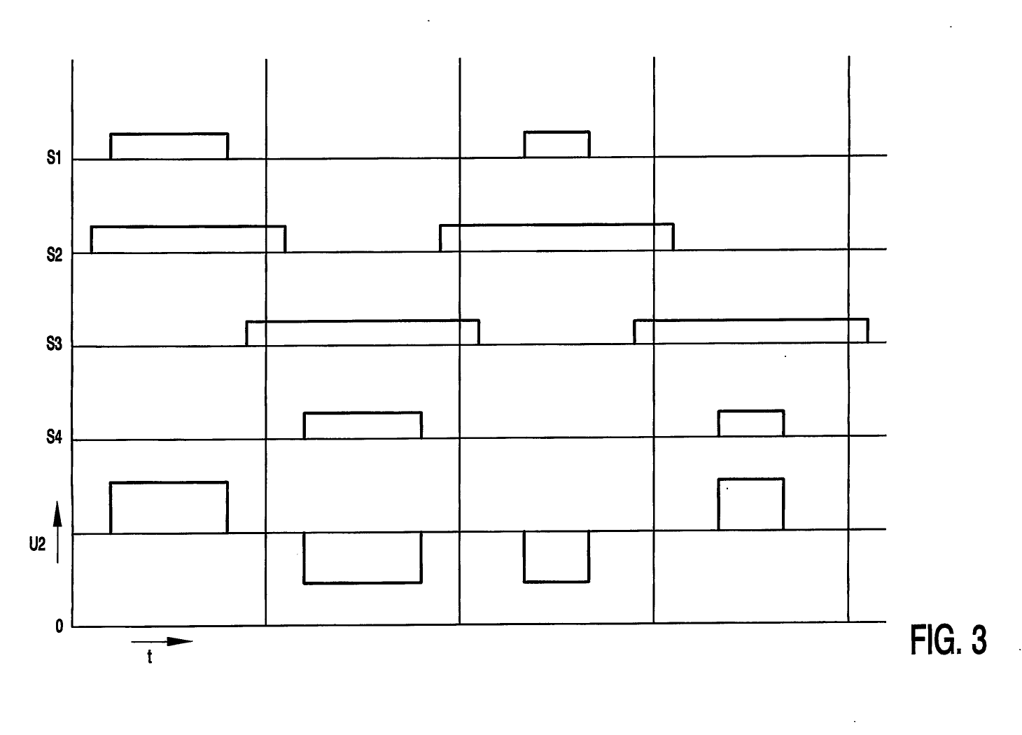

FIG. 3 shows a time diagram of the position of the switch elements and the resulting output voltage.

The prior art circuit depicted in FIG. 1 comprises two inputs 1,2 to be connected to a DC supply source and between which a series connection of two switch elements 11 and 14 have been connected. The junction between the two switch elements 11, 14 is connected with the TL-lamp 15, and in series with the TL-lamp 15 an inductor 16 has been provided. The other connection of the TL-lamp 15 is connected with a series connection of two capacitors 3,4 with a substantially equal capacitance, of which the junction is connected with the TL-lamp 15.

Further a control circuit 5 has been provided for control of the switch elements 11 and 14. It is noted that these switch elements 11,14 will usually be formed by semiconductor elements, free wheel diodes must connected anti parallel with the switch elements.

To avoid short circuits between the inputs 1 and 2, the control circuit is adapted to close only one of the switch elements 11 or 12. As it is impossible to open one of the switch elements and close the other simultaneously it is unavoidable that during short periods both switch elements will be closed. During these periods the voltage on the junction between those switch elements is only determined by parasitic capacitances and inductances leading to a fluctuating voltage and hence flickering of the lamp.

The circuit according to the present invention which is depicted in FIG. 2 avoids these problems by the presence of two additional switching elements 11-14

This circuit according to the invention comprises just as in the prior art two inputs 1,2 to supply a DC voltage.

Between these inputs 1,2 a series connection of two capacitors 3,4 with a substantial equal value is provided. These capacitors have a substantial value, so that it is advantageous to implement these capacitors as electrolytic capacitors although other types are not excluded. These capacitors serve to derive an intermediate voltage from the two supply voltages. It will be clear that in situations wherein such an intermediate voltage is already available, the capacitors will not be needed.

Further a series connection of four switch elements 11,12,13,14 is provided between the inputs 1,2. The junction between the middle switch elements 12,13 is connected with the TL-lamp 15, of which the other connection is connected with the junction between the capacitors 3,4 to apply the intermediate voltage. It will be clear that in situations wherein the intermediate voltage from external sources is available, the lamp will be connected to said source for an intermediate voltage. Further an inductor 16 is connected in series with the lamp.

The cathode of a diode 17 is connected with the junction between the switch elements 11 and 12, while the anode of the diode 17 is connected with the junction between the capacitors 3 and 4. The anode of a diode 18 is connected with the junction of the switch elements 13 and 14, while the cathode of the diode 18 is connected with the junction of the capacitors 3 and 4.

A control circuit 5 has been provided to control the opening and closure of the switch elements 11-14.

Subsequently the operation of this circuit will be described with the help of the diagram depicted in FIG. 3.

Departing from a situation wherein all switch elements 11,12,13,14 are open, which is depicted at t=0 in FIG. 3, initially switch element 12 is closed, so that the lamp is connected to the intermediate voltage. This avoids flickering of the lamp. Shortly afterwards switch element 11 is closed, so that the voltage from input 1 is applied to the lamp. After a certain period, switch 11 is opened again, interrupting the application of voltage to the lamp. Again the lamp is connected with the intermediate voltage.

As a preparation for the connection to the lower voltage, switch element 13 is closed, providing another connection to the intermediate voltage. This allows the switch element 12 to open, while maintaining the connection to the intermediate voltage. Subsequently the switch element 14 can be closed, connecting the lamp to the negative voltage. It will be clear that many variations can be applied to the disclosed circuit without departing from the scope of the invention.

Again this negative voltage can be applied to the lamp for a certain period, after which the switch element 14 can be opened, cutting of the voltage supply, and connecting the lamp to the intermediate voltage. This situation offers the possibility to close the switch element 12, open the switch element 13 and start the cycle over again.

By controlling the duty cycle of the periods during which a positive or a negative voltage is applied to the lamp, the power supplied the lamp 15 can be controlled, executing a dimming function. This is depicted in the second half of FIG. 3 during which the periods in which a positive voltage or a negative voltage is supplied to the lamp is remarkable shorter than in the first half of the diagram.

The diodes serve to avoid short circuits during periods wherein the switch elements 11 and 14 are closed, and provide a connection with the intermediate voltage otherwise.

In the control of the switch elements care should be taken to open any three of the switch elements at any time as this would lead to a short circuit.

It will be clear that many variations can be applied to the disclosed circuit without departing from the scope of the invention.

1. DC/AC converter for supply of TL-lamps, comprising:
a first input to be connected to a positive DC voltage;
a second input to be connected to a negative DC voltage;
a third input to be connected to a ground voltage;
a series connection of a first, a second, a third and a fourth switch element between the first connection and the second connection;
a first diode of which the anode is connected to the third input and of which the cathode is connected to the junction of the first and the second switch element;
a second diode of which the anode is connected to the junction between the third and the fourth switch element and the cathode of the diode is connected to the third input;
an inductor, connected between the junction between the second and third switch elements and a first output; wherein the TL-lamp is to be connected between the first and the second output;
a second output connected to third input; and
a control circuit for controlling the first to fourth switch elements, such that subsequently a ground voltage, a positive voltage, a ground voltage, a negative voltage and a ground voltage is obtained on the first output, wherein the TL-lamp is to be connected between the first an the second output.

2. DC/AC converter as claimed in claim 1, characterized in that the third input is connected to the first input by a first capacitor, and to the second input by a second capacitor, wherein both capacitors have substantially the same capacitance.

3. DC/AC converter as claimed in claim 1, characterized in that each of the switch elements is formed by a semiconductor switch element and that each of the switch elements comprises a bypass diode connected anti-parallel to the semiconductor element.

4. DC/AC converter as claimed in claim 3, characterized in that the switch elements and the control circuit are incorporated into a single semiconductor chip.

5. DC/AC converter as claimed in claim 1, characterized in that the control circuit is adapted to control the effective output voltage through pulse width modulation.
